(19) United States
(12) Patent Application Publication
(10) Pub. No.: US 2002/0197429 A1
(43) Pub. Date: Dec. 26, 2002

(54) Vehicle drip mat

(76) Inventor: Gerald D. Dehn, Mankato, MN (US)

Correspondence Address: MOORE & HANSEN, 2900 WELLS FARGO CENTER, 90 SOUTH SEVENTH STREET, MINNEAPOLIS, MN, 55402, US

(21) Appl. No.: 09/885,463

(22) Filed: Jun. 20, 2001

(51) Int. Cl. B32B 1/08

(52) U.S. Cl. 428/36.9; 428/192

(57) ABSTRACT

A drip mat having removable barrier members inserted into sleeves formed around the periphery of a ground sheet is herein disclosed. The drip mat is readily stowed for sale or transport by removing the barrier members from the sleeves formed around the periphery of the ground sheet. In this manner, the barrier members may themselves be readily replaced or repaired as required.

### CROSS REFERENCE TO RELATED APPLICATIONS

NONE

### FIELD OF THE INVENTION

The present invention relates to a mat that is placed under a parked vehicle to prevent water and other liquids or solids on the vehicle from falling onto the surface on which the vehicle is parked. More specifically, the present invention relates to a mat that may be easily folded or rolled into a relatively small packet for storage.

### BACKGROUND OF THE INVENTION

For the owners of motor vehicles, whether from the north or from warmer climes, it is often desirable to park one's vehicle on a mat or other structure that will prevent liquids or solids from falling from the vehicle onto the surface on which the vehicle is parked. This is especially true where the vehicle in question is under repair, has persistent leaks of fluids, or where the vehicle is regularly exposed to sleet, snow, or rain. The provision of a mat or other drip catching structure prevents damage to the surface on which the vehicle is parked, facilitates rapid clean-up, and prevents damage to other objects placed on the surface on which the vehicle is parked.

Many types of mats or drip-catching structures are available to vehicle owners. Examples of structures of this kind include: examples of patents. All of these structure suffer from a severe lack of flexibility, in both a literal and figurative sense. For the most part, the mats of the prior art are relatively rigid and are intended for use in a single location and are not easily moved or removed. In addition, in northern portions of the United States, it is often desirable to utilize such a mat during the winter months to prevent ice melt from spreading across a garage floor and to put the mat up during the more temperate months. This practice extends the life of the mat and recognizes the reduced need for such a mat during the summer months. Unfortunately, the mats of the prior art are not well adapted to this practice. As indicated above, the mats of the prior art are relatively rigid and not easily moved or stored.

### SUMMARY OF THE INVENTION

Accordingly, it is an object of the present invention to provide a mat structure that is flexible in both the literal and figurative senses and which may easily be broken down, stored, and reassembled. It is an additional object of the present invention to provide a mat structure that is sturdy, inexpensive, and easily repaired.

The vehicle drip mat of the present invention addresses the foregoing objects and comprises a flexible, water proof ground sheet that has a front edge, a rear edge, and first and second lateral edges. The ground sheet is also preferably resistant to petrochemicals and to other substances commonly encountered in a garage or shop setting. The front edge, rear edge, and first and second lateral edges of the ground sheet are doubled over and secured itself so as to form a front sleeve, a rear sleeve, and first and second lateral sleeves, respectively. Seams in the ground sheet of the drip mat of the present invention are preferably joined using vulcanization, though the seams may be sewn and later waterproofed. The respective sleeves extend around substantially all of the periphery of the ground sheet. A plurality of elongate barrier members, each having a predetermined height, width and length, are constructed and arranged for insertion into the front, rear, and first and second lateral sleeves to form a raised barrier around substantially all of the periphery of the ground sheet. The barrier members are removable from their respective sleeves so that the ground sheet may be stowed in a compact manner.

The front and rear elongate barrier members are preferably of an approximate height of ¾″ and are substantially solid. The front and rear elongate barrier members preferably have a beveled leading edge and a beveled trailing edge, although any rounded surface that does not create a pinch point that may damage the ground sheet may be used. The first and second elongate lateral barrier members are preferably a hollow tubular members.

One of the main benefits of the present invention is that the ground sheet may be rolled into a compact substantially cylindrical solid shape when at least two parallel elongate barrier members are removed from the sleeves thereof. Alternatively, where all of the barrier members are removed from the sleeves of the ground sheet, the ground sheet may be folded or rolled into a very compact rectangular or cylindrical shape.

These and other objectives and advantages of the invention will appear more fully from the following description, made in conjunction with the accompanying drawings wherein like reference characters refer to the same or similar parts throughout the several views.

### BRIEF DESCRIPTION OF THE DRAWINGS

FIG. 1 is a plan view of a vehicle floor mat of the present invention.

FIG. 2 is a cross-sectional view of an edge of the vehicle floor mat taken along cutting lines 2-2.

FIG. 3 is a cross-sectional view of an edge of the vehicle floor mat of FIG. 1 taken along cutting lines 3-3.

FIG. 4 is a cross-sectional view of a seam of the vehicle floor mat of FIG. 1 taken along cutting lines 4-4.

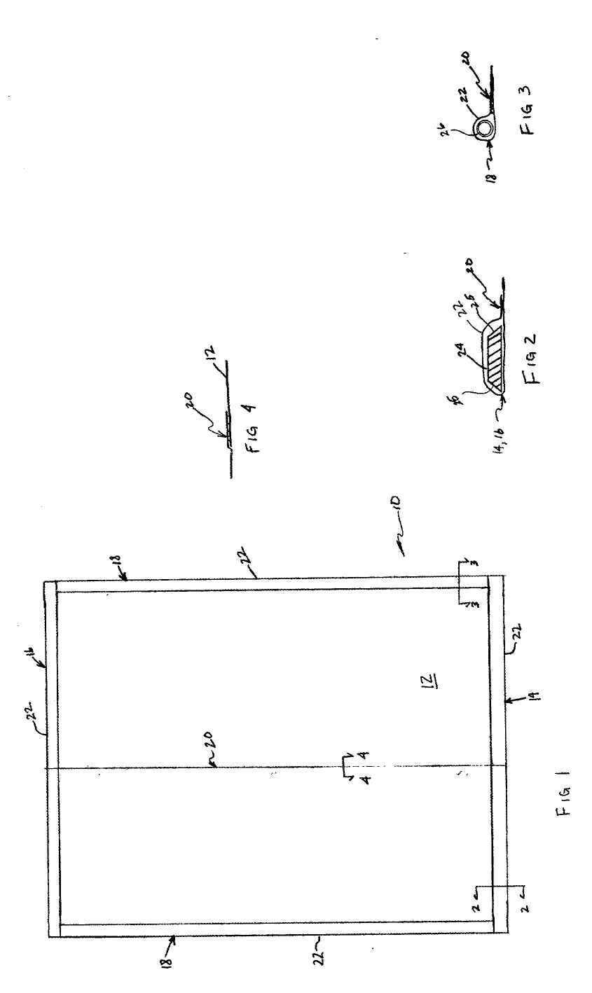

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structure. While the preferred embodiment has been described, the details may be changed without departing from the invention, which is defined by the claims.

A vehicle floor mat 10 of the present invention comprises a substantially planar membrane or ground sheet 12 having a front edge 14, a rear edge 16, and opposing side edges 18. The floor mat 10 of the present invention is preferably sized to be larger than a vehicle that would be placed thereon, though it is contemplated that floor mats 10 having varying sizes and shapes may be constructed according the principles of the present invention. For example, the floor mat 10 may be smaller and suitably shaped so as to underlie pre-selected portions of a vehicle only, such as the engine compartment of an automobile. Alternatively, a vehicle floor mat 10 may be sized to accommodate a plurality of vehicles at one time.

The membrane 12 of the vehicle floor mat 10 is fashioned of a waterproof and relatively elastic material and has the added benefit of being substantially impervious to fluids that are commonly found in a garage type setting. For example, it is preferred that the membrane 12 be waterproof and substantially resistant to petrochemicals such as gasoline and oil and also to other fluids such as coolants, power steering fluid, transmission fluids, and various solvents and cleaners. It is also preferred that the membrane 12 be relatively thin so that the total weight of the vehicle floor mat 10 will be minimized. The material from which the membrane 12 is fashioned is preferably an EPDM single ply rubber sheeting manufactured by FIRESTONE, INC. This material has a tensile strength of approximately 1305 PSI and an elongation coefficient of approximately 300%.

Typically, the material from which the membrane 12 is fashioned is obtained on a roll that generally has a width that is smaller than a typical automobile. Therefore, it is often necessary to connect one or more strips of the membrane material to form membrane 12. The strips of material may be joined at seam 20 as by sewing, adhesive, or by vulcanization, with vulcanization being the preferred method for joining the two portions of membrane material. The seam 20 may be formed as a lapped seam, a cap-stripped seam, a butt seam, an envelope seam, a standing seam, or any other suitable configuration. A lapped seam 20 is preferably formed by overlapping the edges of the membrane material and applying heat to these lapped edges under pressure so as to melt the lapped edges of the membrane material together. Vulcanization is preferable in the fabrication of the vehicle floor mat 10 in that vulcanization omits the needle holes that are required in sewn membranes. The omission of these needle holes prevents leakage of fluids through the mat 10 through the needle holes.

Once a membrane 12 having a predetermined size is obtained, a plurality of sleeves 22 are formed at the front, back, and side edges, respectively. Each of the sleeves 22 is preferably fashioned by folding a portion of the membrane material 12 over onto itself. A seam 20, such as that illustrated in FIGS. 2 and 3, is used to secure the doubled membrane material to itself to form sleeves 22. As can be seen in FIG. 2, in order to form the raised front and rear edges 14, 16, an elongate barrier member 24 may be placed within the front and back edge seams 22. It is preferred that the barrier members utilized in the front and back sleeves 22 be solid in nature. Because the front and rear sleeves 22 will be frequently run over by the wheels of a vehicle that is placed on the vehicle floor mat 10, it is preferred to use a solid material such as a wooden board or slat having beveled faces 25. A preferred embodiment uses a simple pine board that is ¾″ thick by approximately four inches wide. The leading and trailing edges of the pine board are beveled at approximately 45° though various other angles may be satisfactorily used. Note that it is also possible for the beveled faces 25 to be gradually rounded. In this manner, as the wheels of a vehicle pass over the front or rear edges of the floor mat 10, the membrane material 12 will not be cut between the vehicle wheel and the barrier member 24. The sleeves 22 of the opposing side edges 18 are sized to receive an elongate barrier member 26 therein. The side members 26 may be solid or may be hollow as illustrated in FIG. 3. Because the side members will not typically be driven upon, relatively inexpensive tubing such as galvanized steel electrical conduit may be utilized as a side member 26. Note that it is preferred to leave the ends of the sleeves 22 open so that the front members 24 and side members 26 may be readily removed and inserted.

One of the main benefits of the floor mat 10 of the present invention is that it may be quickly and easily broken down for storage, transport, or sale. In its operative mode, the vehicle floor mat 10 of the present invention is opened so that the membrane 12 thereof lays flat upon a floor. The front and rear barrier members 24 and the side members 26 are then inserted into their respective sleeves 22. The presence of the front and rear barrier members 24 and side barrier members 26 within the sleeves 22 creates a pan-like raised perimeter around the vehicle floor mat 10 such that liquids falling from a vehicle stationed upon the mat 10 will be retained upon the membrane 12 thereof. Cleanup of the fluids deposited upon the vehicle floor mat 10 is relatively straightforward. Water may simply be allowed to evaporate or may be vacuumed therefrom using a wet/dry vacuum or may be swept over the raised perimeter of the floor mat 10. Other fluids contained on the floor mat may be cleaned up by placing a suitable sweeping compound thereover, waiting for the various fluids to become absorbed by the sweeping compounds, and then by sweeping up or vacuuming the saturated sweeping compounds.

Where a user of the floor mat 10 desires to break the floor mat down for storage, the user will remove the front and rear barrier members 24 and the side barrier members 26 from the sleeves 22. The membrane 12 of the floor mat 10 may then be folded into a relatively small bundle for storage or transport. Alternatively, two or more of the barrier members 24, 26 may be removed from their sleeves 22 so that the membrane 12 may be rolled up on the remaining barrier member to form a compact cylindrically roll. The elongate barrier members may be stored independent from the membrane 12 or, alternatively, where the barrier members 24, 26 have all been removed, the membrane 12 may be wrapped around the barrier members 24, 26 to again form a substantially cylindrical roll having a relatively small diameter. As can be readily appreciated, the vehicle floor mat 10 of the present invention is easily assembled, disassembled, and stored and provides an excellent means for protecting the floors in a garage or shop setting. When the barrier members 26 have been removed, the vehicle floor mat 10 may be rolled into a cylindrical roll having a diameter of no more than eight inches and a length of approximately seven and one half feet long, though the length will ultimately depend upon the width of the vehicle floor mat 10 itself.

The invention described above may be embodied in other forms without departing from the spirit or essential characteristics thereof. The embodiments disclosed in this application are to be considered in all respects as illustrative and not restrictive. The scope of the invention is indicated by the appended claims rather than by the foregoing description and all changes which come within the meaning and range of equivalency of the claims are intended to be embraced therein.

What is claimed is:

1. A vehicle drip mat comprising:
a flexible, water proof ground sheet having a front edge, a rear edge, and first and second lateral edges that form the periphery of the ground sheet, the front edge, rear edge, and first and second lateral edges of the ground sheet being doubled over and secured to the ground sheet so as to form a front sleeve, a rear sleeve, and first and second lateral sleeves, the respective sleeves extending around substantially all of the periphery of the ground sheet;
a plurality of elongate barrier members each having a predetermined height, width and length, the barrier members being constructed and arranged for insertion into the front, rear, and first and second lateral sleeves, the barrier members being sufficiently long to form a raised barrier around substantially all of the periphery of the ground sheet, the barrier members being remove able from their respective sleeves so that the ground sheet may be stowed in a compact manner.

2. The vehicle drip mat of claim 1 wherein the elongate barrier members are approximately ¾″ in height.

3. The vehicle drip mat of claim 1 wherein the front and rear elongate barrier members are substantially solid and have a beveled leading edge and a beveled trailing edge.

4. The vehicle drip mat of claim 1 wherein the front and rear elongate barrier members are substantially solid and have a rounded leading edge and a rounded trailing edge.

5. The vehicle drip mat of claim 1 wherein the first and second elongate barrier members are hollow.

6. The vehicle drip mat of claim 5 wherein the first and second elongate barrier members comprise tubular members.

7. The vehicle drip mat of claim 1 wherein the sleeves are formed by one of sewing and vulcanization.

8. The vehicle drip mat of claim 1 wherein the ground sheet may be folded into a substantially rectangular solid shape when the elongate barrier members are removed from the sleeves thereof.

9. The vehicle drip mat of claim 1 wherein the ground sheet may be rolled into a substantially cylindrical solid shape when at least two parallel elongate barrier members are removed from the sleeves thereof.

10. The vehicle drip mat of claim 1 wherein the ground sheet is petrochemical resistant.

11. A portable and stowable drip mat comprising:
a flexible, waterproof ground sheet having a peripheral edge, with at least one sleeve formed there around for removably receiving therein at least one barrier member, the ground sheet being capable of being compactly folded or rolled when the at least one barrier member is removed from the at least one sleeve.

12. The portable and stowable drip mat of claim 11 wherein the periphery of the ground sheet comprises a front edge, a rear edge, and a first and a second lateral edge, each edge further comprising a sleeve for receiving therein respective barrier members.

13. The portable and stowable drip mat of claim 12 wherein the front and rear members are substantially solid so as to resist the weight of a vehicle without being crushed.

14. The portable and stowable drip mat of claim 13 wherein the front and rear members have a beveled leading edge and a beveled trailing edge.

15. The portable and stowable drip mat of claim 11 wherein the ground sheet may be folded into a substantially rectangular solid shape when all of the barrier members are removed from the sleeves thereof.

16. The portable and stowable drip mat of claim 11 wherein the ground sheet may be rolled into a substantially cylindrical solid shape when at least two parallel barrier members are removed from the sleeves of the ground sheet.
